(19) United States
(12) Patent Application Publication
(10) Pub. No.: US 2025/0368291 A1
(43) Pub. Date: Dec. 4, 2025

(54) STEERER DEVICE

(71) Applicant: SRAM, LLC, CHICAGO, IL (US)

(72) Inventors: MICHAEL MAXWELL, COLORADO SPRINGS, CO (US); BRENT PACKER, MANITOU SPRINGS, CO (US); CHARLES DUNLAP, COLORADO SPRINGS, CO (US)

(73) Assignee: SRAM, LLC, CHICAGO, IL (US)

(21) Appl. No.: 19/219,223

(22) Filed: May 27, 2025

Related U.S. Application Data
(60) Provisional application No. 63/653,049, filed on May 29, 2024.

(51) Int. Cl. B62K 25/08; B62K 21/02; B62K 21/04

(52) U.S. Cl. CPC B62K 25/08; B62K 21/02; B62K 21/04

(57) ABSTRACT

A steerer device for a two-wheeled vehicle is provided. The steerer device may generally include a steerer adaptable for handlebar control and rotatable about a steering axis, at least one fork leg assembly, the at least one fork leg assembly including a wheel mounting interface, and a crown connecting the steerer and the at least one fork leg assembly. At least one rotational stop may be fixed on the crown, the at least one rotational stop sized and shaped to limit rotation of the crown about the steering axis.

This application claims the benefit of U.S. Provisional Patent Application 63/653,049, filed May 29, 2024, the contents of which is hereby incorporated by reference in its entirety.

### FIELD OF THE DISCLOSURE

The present application generally relates to front forks for bicycles, and more particularly to a mechanical rotation stop integrated with a suspension fork.

### BACKGROUND

Bicycles are known to have suspension components. Suspension components have been used for various applications, such as cushioning impacts, vibrations, or other disturbances experienced by the bicycle during use. A common application for suspension components on bicycles is for cushioning impacts or vibrations experienced by the rider when the vehicle is ridden over bumps, ruts, rocks, potholes and/or other obstacles. These suspension components include rear and/or front wheel suspension components. Suspension components may also be used in other locations, such as a seat post or handlebar, to insulate the rider from impacts.

For a front wheel, a front fork may include suspension elements such as springs and dampers. Such suspension elements have values and characteristics associated with use in a suspension system. For example, a spring element, such as a coil spring, elastomeric spring, air spring, and/or other spring element will have a spring force value, which may be constant or variable along an established curve depending on the input force or displacement value. It is often desirable to control the effect of such spring elements using a damping element or system. Damping elements in suspensions will also include characteristic values. For example, damping rates, such as rebound and compression rates, may be established based on the physical characteristics of the particular damper and/or suspension system.

Bicycle forks formed as suspension elements, or suspension forks, typically include several elements. For example, suspension forks often include at least one leg, typically two legs, configured with spring and/or damper systems. The suspension fork legs include a wheel attachment portion at one end configured for rotational attachment of a bicycle wheel. For example, the wheel attachment portion may include a dropout, through axle, or other mechanism for wheel attachment. The other end of the legs is typically attached to a frame connection portion of the suspension fork. For example, many suspension forks with two legs are connected at the other end with a coupling device such as a crown. Further, typical bicycle suspension forks will include a steerer tube that will attach to the crown and extend in an opposing direction from the legs. The steerer tube is configured to rotatably attach to the frame of the bicycle at a rotatably enabled connection portion of the frame. The rotatably enabled connection portion of the frame typically will include a through hole in which the steerer tube may be inserted, and an arrangement of a rotation arrangement mechanism, for example bearings of a headset for a bicycle.

Suspension forks may be implemented on bicycles intended for aggressive environments, such as hilly and/or rocky terrain. In these environments over-rotation of the suspension fork relative to the frame may cause an improper loading of the suspension systems and/or instability of the bicycle due to impacts on the front wheel. For example, cabling interference, handlebar interference, and/or crown interference may occur with over-rotation.

### SUMMARY

An object of this disclosure is to provide various steerer devices for two-wheeled vehicles. Steerer devices may generally be employed with forks, for example suspension forks, that may be used with various two-wheeled vehicles like bicycles or motorcycles. Steerer devices as described herein may be used to control rotation of a fork relative to a frame, for example to prevent problems associated with over-rotation of a fork such as impact and/or control element binding or strain. Steerer devices as used herein can beneficially control loading at extreme rotation events to reduce the likelihood of adverse consequences.

One aspect provides a steerer device for a two-wheeled vehicle, the steerer device comprising: a steerer adaptable for handlebar control and rotatable about a steering axis; at least one fork leg assembly, the at least one fork leg assembly including a wheel mounting interface; a crown connecting the steerer and the at least one fork leg assembly; and at least one rotational stop fixed on the crown, the at least one rotational stop sized and shaped to limit rotation of the crown about the steering axis.

Another aspect provides a suspension fork for a two-wheeled vehicle, the suspension fork comprising: a steerer adaptable for handlebar control and rotatable about a steering axis; at least one fork leg assembly, the at least one fork leg assembly including a wheel mounting interface; a crown connecting the steerer and the at least one fork leg assembly; and at least one rotational stop fixed on the crown, the at least one rotational stop sized and shaped to limit rotation of the crown about the steering axis.

Yet another aspect provides a suspension fork for a two-wheeled vehicle, the suspension fork comprising: a steerer adaptable for handlebar control and rotatable about a steering axis; at least one fork leg assembly, the at least one fork leg assembly including a wheel mounting interface; a crown connecting the steerer and the at least one fork leg assembly; and at least one rotational stop fixed on the crown, the at least one rotational stop sized and shaped to interface with a limiting feature to limit rotation of the crown about the steering axis.

### BRIEF DESCRIPTION OF THE DRAWINGS

FIG. 1 is a side elevation view of a bicycle which may employ a steerer device as described herein.

FIG. 2 is a front elevation view of a front fork for a bicycle which may employ a steerer device as described herein.

FIG. 3 is a perspective view of the front fork of FIG. 2.

FIG. 4 is an enlarged perspective view of the front fork shown in FIG. 3.

FIG. 5 is a perspective view of a crown that may be employed with a front fork for a bicycle.

FIG. 6 is a rear elevation view of the crown of FIG. 5.

FIG. 7 is a sectional view of the crown of FIG. 5 taken along cut line 7-7 in FIG. 6.

FIG. 8 is an enlarged sectional view of the crown shown in FIG. 7 as indicated by callout 8.

FIG. 9 is a top elevation view of the crown of FIG. 5.

FIG. 10 is a side elevation view of a front fork mounted to a bicycle which may employ a steerer device as described herein.

FIG. 11 is a sectional view of the front fork of FIG. 10 taken along cut line 11-11.

FIG. 12 is an enlarged side elevation of the front fork of FIG. 10 as indicated by callout 12.

FIG. 13 is a sectional view of the front fork of FIG. 10 taken along cut line 13-13 in FIG. 11.

FIG. 14 is a side elevation view of the front fork of FIG. 10 shown at a rotated position.

FIG. 15 is a sectional view of the front fork of FIG. 14 in its rotated position taken along cut line 15-15.

FIG. 16 is an enlarged side elevation view of the front fork of FIG. 14 as indicated by callout 16.

FIG. 17 is a sectional view of the front fork of FIG. 14 in its rotated position taken along cut line 17-17.

FIG. 18 is an exploded perspective view of a crown assembly for a front fork of a bicycle which may employ a steerer device as described herein.

FIG. 19 is a top elevation view of the crown assembly of FIG. 18.

FIG. 20 is a rear elevation view of the crown assembly of FIG. 18 in an assembled state.

FIG. 21 is a sectional view of the crown assembly of FIG. 18 in its assembled state, taken along cut line 21-21 in FIG. 20.

FIG. 22 is an exploded perspective view of a crown assembly for a front fork of a bicycle which may employ a steerer device as described herein.

FIG. 23 is a top elevation view of the crown assembly of FIG. 22.

FIG. 24 is a rear elevation view of the crown assembly of FIG. 22 in an assembled state.

FIG. 25 is a sectional view of the crown assembly of FIG. 22 in its assembled state, taken along cut line 25-25 in FIG. 24.

FIG. 26 is an exploded perspective view of a crown assembly for a front fork of a bicycle which may employ a steerer device as described herein.

FIG. 27 is a top elevation view of the crown assembly of FIG. 26.

FIG. 28 is a rear elevation view of the crown assembly of FIG. 26 in an assembled state.

FIG. 29 is a sectional view of the crown assembly of FIG. 26 in its assembled state, taken along cut line 29-29 in FIG. 28.

The figures are not to scale. Instead, the thickness of the layers or regions may be enlarged in the drawings. In general, the same reference numbers will be used throughout the drawing(s) and accompanying written description to refer to the same or like parts.

### DETAILED DESCRIPTION

Limiting the rotation of the suspension fork can address issues of over-rotation. Provided herein are examples of embodiments for integrating a rotation stopping mechanism with a crown of a front fork.

In an embodiment, a crown fixed steerer stop includes mating stops on a lower headset cup or bike frame in proximity to a lower headset.

In an embodiment, a fork crown includes a bearing race feature on an upper surface directed towards the direction in which a steerer tube extends. The upper surface may be attached to the crown, formed of with the crown as a single-unitary piece, or some combination thereof. The upper surface includes at least one protrusion configured define a maximum steering rotation angle. The protrusions may be formed as integral portions of the fork crown, or may be attachable or attached to the fork crown.

In an embodiment the maximum rotation angle may be adjustable.

In an embodiment, a fork crown includes a steerer bore axis and a bearing race mating surface on an upper most surface. At least one key, for example a recessed key, may be disposed on the upper most surface.

In an embodiment, a recessed key may be configured to accept a limiting feature such as a reciprocally configured bearing race and/or protrusion key. The recessed key may constrain the bearing race and/or protrusion key from rotation about the crown bore axis, which may be the same as the steerer access/steerer bore axis. The protrusion key, or otherwise configured bearing race, is sized, shaped, and positioned to define a maximum steering rotation angle of the suspension fork relative to the frame.

In an embodiment, a bearing race mating surface and/or recessed key surface may include fastener holes. The fastener holes may provide for adjustment of a rotation angle. Other techniques, such as slots or other features, may be used.

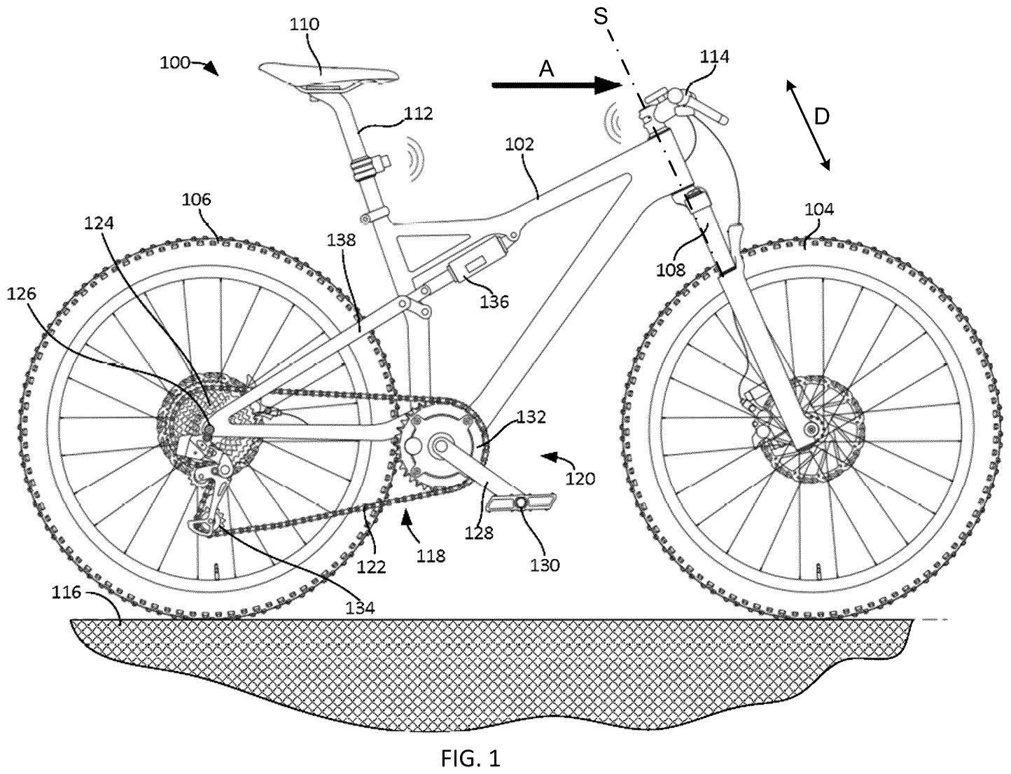

Turning now to the figures, FIG. 1 illustrates one example of a human powered vehicle on which the example front forks disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 coupled to the frame 102 (e.g., near the rear end of the frame 102 relative to the forward direction A) via a seatpost 112. The bicycle 100 also includes handlebars 114 coupled to the front fork 108 (e.g., near a forward end of the frame 102 relative to the forward direction A) for steering the bicycle 100. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device (not shown) to move the chain 122 through gears on the chainring 132.

The example bicycle 100 includes a suspension system having one or more suspension components. In this example, the front fork 108 is implemented as a front suspension component. The front fork 108 is or integrates a shock absorber that includes a spring and a damper, disclosed in further detail herein. Further, in the illustrated example, the bicycle 100 includes a rear suspension component 136, which is a shock absorber, referred to herein as the rear shock absorber 136. The rear shock absorber 136 is coupled between two portions of the frame 102, including a rear triangle, also referred to herein as a swing arm 138 coupled to the rear wheel 106. The front fork 108 and the rear shock absorber 136 absorb shocks and vibrations while riding the bicycle 100 (e.g., when riding over rough terrain). In other embodiments, the front fork 108 and/or the rear shock absorber 136 may be integrated into the bicycle 100 in other configurations or arrangements. Further, in other embodiments, the suspension system may employ only one suspension component (e.g., only the front fork 108) or more than two suspension components (e.g., an additional suspension component on the seat post 112) in addition to or as an alternative to the front fork 108 and rear shock absorber 136.

While the example bicycle 100 depicted in FIG. 1 is a type of mountain bicycle, the example front forks (and/or lower housings or housings) disclosed herein can be implemented on other types of bicycles. For example, the disclosed front forks may be used on various road, gravel, time trial, or triathlon bicycles, as well as bicycles with mechanical (e.g., cable, hydraulic, pneumatic, etc.) and non-mechanical (e.g., wired, wireless) drive systems. The disclosed front forks can also be implemented on other types of two-wheeled, three-wheeled, and four-wheeled human powered vehicles. Further, the example front forks can be used on other types of vehicles, such as motorized vehicles (e.g., a motorcycle, a car, a truck, etc.).

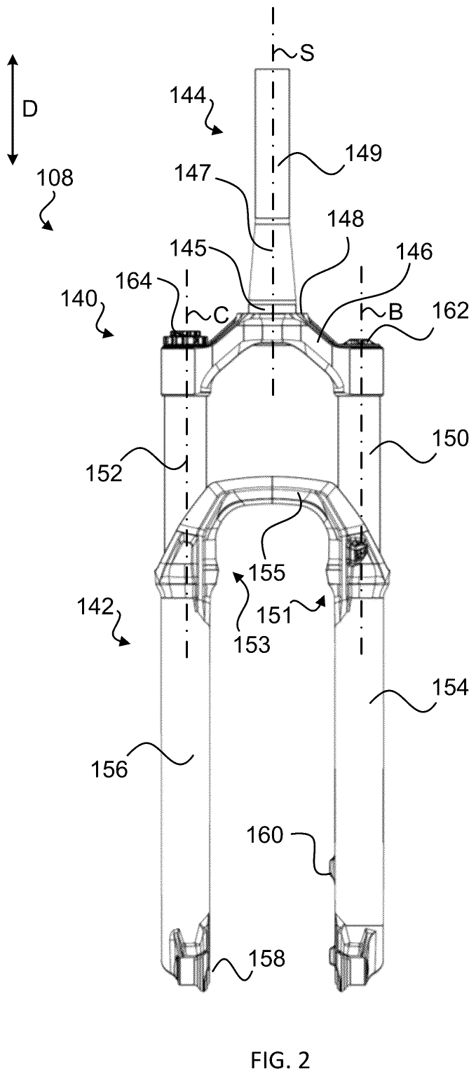

Turning now to FIG. 2, a front view of a front fork 108 is provided. As described above, the front fork 108 may be a suspension fork as shown in FIG. 2. Generally, the elements of the front fork 108 shown in FIG. 2 can be described as part of a fork upper 140 or part of a fork lower 142. The fork upper 140 generally includes elements that are suspended by the operation of the front fork 108 (i.e. sprung elements). The fork lower 142 generally includes elements that are not suspended by the operation of the front fork 108 (i.e. unsprung elements). It should be appreciated that the elements of the fork upper 140 and the fork lower 142 do not provide an exclusive list of elements of the front fork 108. Various elements of the front fork 108 may be provided which are not specifically elements of the fork upper 140 or the fork lower 142. For example, certain internal elements and/or external linkage elements (not shown) in certain embodiments may include components that are not directly fixed relative to the fork upper 140 or the fork lower 142 but are still considered components of the fork 108.

The fork upper 140 shown in FIG. 2 includes a steerer 144 configured for mounting to the frame of a bicycle (i.e. the frame 102 of the bicycle 100 of FIG. 1). The steerer 144 as shown includes a steerer lower portion 145, a steerer upper portion 149, and a steerer transition portion 147 disposed therebetween. The arrangement provided in FIG. 2 may also be described as a tapered steerer design, where the steerer upper portion 149 has a relatively small outer dimension or diameter and the steerer lower portion 145 has a relatively large outer dimension or diameter when compared to the steerer upper portion 149. It should also be appreciated that various other designs of the steerer 144 may be provided, for example with a consistent outer dimension or diameter along an entire length of the steerer 144.

As will be described in greater detail below, a steerer device may be provided with various front forks, for example the front fork 108 of FIG. 2. Such a steerer device may generally be provided for any two-wheeled, three-wheeled, or other fork-steered vehicle, whether human powered, motor powered, or partially human powered such as in e-bikes. The steerer device generally includes a steerer, such as the steerer 144 of FIG. 2, adaptable for handlebar control and rotatable about a steering axis S.

The steerer 144 shown in FIG. 2 is attached to a crown 146 of the front fork 108. The steerer lower portion 145 as shown is sized and shaped to be received within a corresponding opening of the crown 146 with an interference fit. Additionally or alternatively, adhesive, welding, or the like may be used to secure the steerer 144 with the crown 146. In an embodiment, the steerer 144 and the crown 146 are formed as a unitary component, for example as a composite or forged metallic component. As will be described in greater detail below, any combined or unitary configuration of the steerer 144 and the crown 146 may be subjected to high rotational impact forces from wheel impacts where a high degree of leverage is potentially involved. Accordingly, minimizing rotational stresses about a steering axis S between the steerer 144 and the crown 146 is advantageous.

Still referring to FIG. 2, a crown interface 148 is provided on the crown 146. The steerer 144 and the crown 146 may be integral or may be separate elements. In examples where the steerer 144 is separately provided from the crown 146, the crown interface 148 generally surrounds the steerer 144 about the steering axis S and may generally describe an opening in the crown 146 through which the steerer 144 is passed during installation. The crown interface 148 may also serve as a bearing reference, for example to directly or indirectly locate a lower headset bearing (not shown). In an embodiment, the steerer 144 and the crown interface 148 cooperate to locate a lower headset bearing (not shown) for installing the front fork 108 to a bicycle frame such as the frame 102 in FIG. 1.

The example of FIG. 2 may further be described with reference to one or more fork legs. For example, a fork may be provided with a single leg. In the example shown, a first leg assembly 151 and a second leg assembly 153 are provided. The first leg assembly 151 includes a first upper leg 150 and a first lower leg 154. The second leg assembly 153 includes a second upper leg 152 and a second lower leg 156. As shown, a lower connector 155, also referred to as a bridge or a leg brace, is provided between the first leg assembly 151 and the second leg assembly 153. The lower connector 155 may be a removable element, for example attachable between the first lower leg 154 and the second lower leg 156 with one or more fasteners. Alternatively, the lower connector 155 may be omitted. As shown in FIG. 2, the lower connector may be integrally formed, for example uniformly cast with a casting of the fork lower 142 including the first lower leg 154 and the second lower leg 156.

In operation, the fork 108 of FIG. 2 facilitates and controls relative movement between the fork upper 140 and the fork lower 142. For example, the first upper leg 150 may be telescopically arranged with the first lower leg 154 and the second upper leg 152 may be telescopically arranged with the second lower leg 156 along respective first and second leg axes. A first leg axis B and a second leg axis C generally define such telescopic movement between the fork upper 140 and the fork lower 142. The first leg axis B and the second leg axis C in FIG. 2 are generally parallel, defining a plane. The plane defined by the first leg axis B and the second leg axis C may entirely include, intersect with, or be offset from the steering axis S. As shown in the example of FIG. 2, the steering axis S is parallel to the first leg axis B and the second leg axis C such that the steering axis S never intersects the plane defined by the first leg axis B and the second leg axis C.

Still referring to FIG. 2, a wheel mounting interface 158 is provided with the fork lower 142. The wheel mounting interface 158 generally facilitates mounting of a wheel, such as the front wheel 104 of FIG. 1, rotatably relative to the front fork 108. The wheel mounting interface 158 is shaped and sized to robustly interface with a wheel such that a strong and reliable connection is ensured. Accordingly, wheel forces are expected to efficiently transmit through the front fork 108. As described above, various control elements may be provided to manage wheel forces through the front fork 108. For example, various configurations of springs and/or dampers may be provided to control wheel forces transmitted generally along the steering axis S.

In the example of FIG. 2, a spring arrangement is provided in the first leg assembly 151 and a damper arrangement is provided in the second leg assembly 153. The spring arrangement may include a coil spring, for example a metallic coil spring, and/or an air spring. A spring interface 162 is provided to allow user adjustment of the spring arrangement. For example, the spring interface 162 may allow a user to increase or decrease pressure in an air spring, change preload on a coil spring, and/or access tuning parts for replacement. A damper interface 164 is also provided. The damper interface 164 may allow a user to control damper characteristics such as compression and rebound speeds. In an embodiment, the damper interface 164 disposed on the crown 146 is a first damper interface and a second damper interface is provided on the second lower leg 156. In this example, the first damper interface is used to control at least one compression damping characteristic and the second damper interface is used to control at least one rebound damping characteristic. In addition to physical controls disposed on the front fork 108, it should be appreciated that various damping and/or spring characteristics may be controlled electronically, for example through wireless control signals transmitted from a bicycle mounted remote user interface or an external device.

Still referring to FIG. 2, a brake mounting interface 160 is also provided. The brake mounting interface 160 may be provided on one or both of the first leg assembly 151 or the second leg assembly 153. As shown in FIG. 2, the brake mounting interface 160 is provided on the first lower leg 154. The brake mounting interface 160 is shaped and sized to receive a braking element, for example a brake caliper (not shown). In this example, the brake caliper (not shown) reacts a braking force from a wheel-mounted brake rotor (not shown) to the first lower leg 154. The first lower leg 154 cooperates with the rest of the front fork 108 through the first leg assembly 151 and the lower connector 155 to generally resolve any braking forces roughly orthogonal to the steering axis S. Elements of the front fork 108 are appropriately shaped and sized to efficiently handle such braking forces.

As described above, the front fork 108 is configured to control wheel forces generally along the steering axis S (i.e. bump forces) and wheel forces generally orthogonal to the steering axis S (i.e. braking forces). Rotational forces, such as those applied by a wheel being turned to an extreme by a trail obstacle or crash incident, may still present problems to fork arrangements. For example, a wheel may be turned to an extreme defined by handlebar, brake lever, or other impact with the frame of the bicycle. In such a scenario, it is advantageous to resolve rotational forces with the crown 146 in order to limit stresses on the interface between the crown 146 and the steerer 144. Particularly in examples where the steerer 144 is installed into the crown 146, extreme rotational forces in these scenarios may affect the interface between the crown 146 and the steerer 144 towards adverse side effects such as creaking or knocking due to increased tolerance. Even in embodiments with a unitary crown 146 and steerer 144, the crown 146 is generally better adapted to resolve these rotational forces.

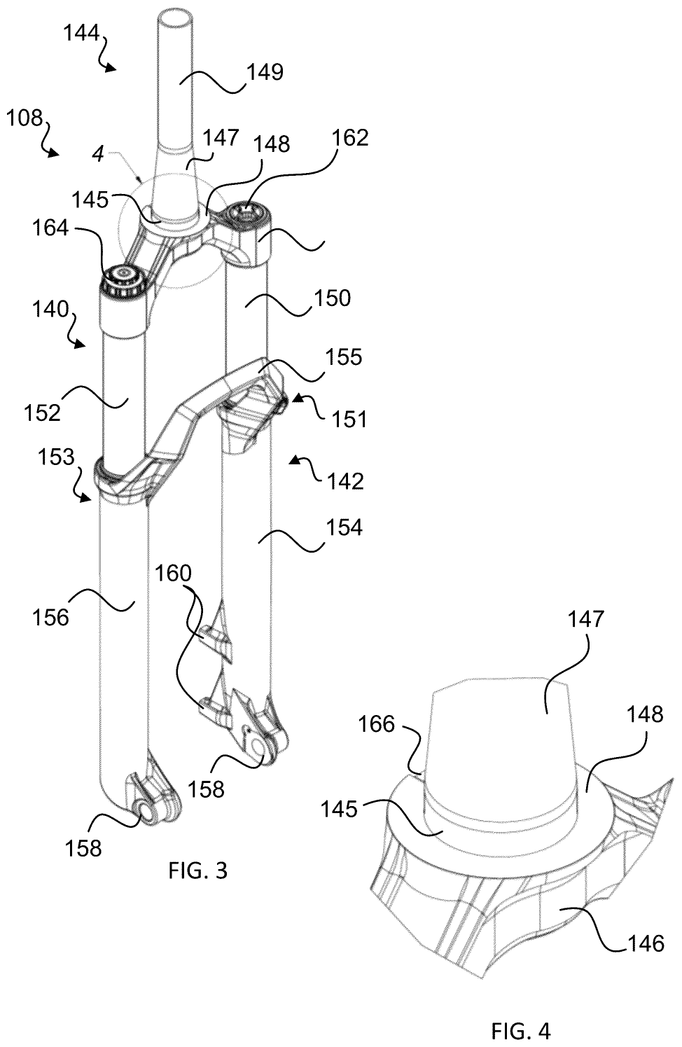

Turning now to FIG. 3, a perspective view of the front fork 108 is provided. In various examples, at least one fork leg assembly includes the wheel mounting interface 158. For example, the example of FIG. 3 provides a portion of the wheel mounting interface 158 on the first leg assembly 151 and another portion of the wheel mounting interface 158 on the second leg assembly 153. The wheel mounting interface 158 may be variously configured, but generally facilitates the attachment and removal of a wheel at its hub. In the present example, the wheel mounting interface 158 includes complimentary surfaces on opposing sides of the first leg assembly 151 and the second leg assembly 153. At least one threaded portion may be provided with the wheel mounting interface 158, for example to receive a threaded end of a quick release skewer and/or a thru-axle skewer. Additionally or alternative, the wheel mounting interface 158 may include one or more securing assemblies, which may include a clamping device, to appropriately preload and secure a wheel hub and/or maintain alignment along the first leg assembly 151 and the second leg assembly 153.

The front fork 108 shown in FIG. 3 includes a first leg assembly 151 and a second leg assembly 153 each configured to telescopically receive a respective upper leg 150, 152 within a respective lower leg 154, 156. However, it should be appreciated that various other arrangements of the front fork 108 may be provided to employ steerer devices as described herein. For example, respective upper leg assemblies may be configured to receive respective lower leg assemblies telescopically therein in what is generally known as an upside down fork arrangement. Additionally or alternatively, a single leg assembly may be provided with no complimentary second leg assembly.

Still referring to FIG. 3, the crown 146 is provided connecting the steerer 144 to the first leg assembly 151 and the second leg assembly 153. Specifically, the crown 146 is engaged with the steerer lower portion 145 of the steerer 144. Spaced apart from this engagement with the steerer 144, the crown 146 is engaged with the first upper leg 150, and on an opposite side of the steerer 144 with the second upper leg 152.

Engagement between the steerer 144 and the crown 146 may be removable, permanent, or semi-permanent. For example, the crown 146 and the steerer may be formed as a unitary component as described above. Alternatively, the steerer 144 may be pressed into and/or adhesively secured within the crown 146. In an embodiment, the steerer 144 may be cryogenically treated prior to insertion within the crown 146 to ensure a tight interference fit therein. In examples where the steerer 144 and the crown 146 are non-unitary components, the steerer lower portion 145 may be installed passing through the crown 146 such that the steerer upper portion 149 is exposed above the crown 146. Generally, the steerer upper portion 149 may be sized and shaped to receive at least one of a handlebar or a handlebar stem to facilitate vehicle steering.

As described above with reference to FIG. 2, one or more of the damper interface 164 or the spring interface 162 may be provided for user engagement or tuning of the front fork 108. For example, the damper interface 164 may facilitate user adjustment of at least one damper characteristic and the spring interface 162 may facilitate user adjustment of at least one spring characteristic. The spring interface 162 may be operable to adjust a preload of a coil spring and/or to adjust a pressure of an air spring. In an embodiment, the spring interface 162 includes at least one valve for pressure adjustment. The damper interface 164 may be operable to adjust an effective orifice size, valve shim preload, and/or effective valve shim stiffness of a damper. For example, the damper interface 164 may adjust such damper characteristics of a rebound circuit and/or a compression circuit.

As shown in FIG. 3 the damper interface 164 is provided in connection with the second leg assembly 153 and the spring interface 162 is provided in connection with the first leg assembly 151. In this example, a spring arrangement (not shown) is provided within the first leg assembly 151 and a damper arrangement (not shown) is provided within the second leg assembly 153. Accordingly, the spring interface 162 may act directly on the spring arrangement (not shown) and the damper interface 164 may act directly on damper arrangement (not shown).

Turning now to FIG. 4, an enlarged view of the front fork 108 is provided, showing detail of the junction between the crown 146 and the steerer 144. Specifically, a relatively small extent of the steerer lower portion 145 protrudes above the crown interface 148 of the crown 146. In various examples, the crown interface 148 and the steerer lower portion 145 protruding there above may cooperate to retain a lower headset bearing (not shown), either directly or indirectly through a crown race (not shown). For example, the crown race (not shown) and/or lower headset bearing (not shown) may be press fit onto the steerer lower portion 145. This protruding extent of the steerer lower portion 145 may serve to locate the fork via various headset elements.

Still referring to FIG. 4, a crown tool access 166 may also be provided in the crown 146. The crown tool access 166 may be provided to facilitate removal of one or more headset elements, for example the crown race or headset bearing as described above. The crown tool access 166 as shown in FIG. 4 is sized and shaped to receive a tool, for example a prying tool, to allow a user to remove various elements. The crown tool access 166 may be particularly useful in facilitating the removal of elements press fit onto the steerer 144 without unduly stressing the junction of the steerer 144 and the crown 146. As will be discussed in greater detail below, the junction of the steerer 144 and the crown 146 may be unduly stressed by certain impacts, potentially leading to undesirable looseness and/or sounds caused by relative movement between the steerer 144 and the crown 146.

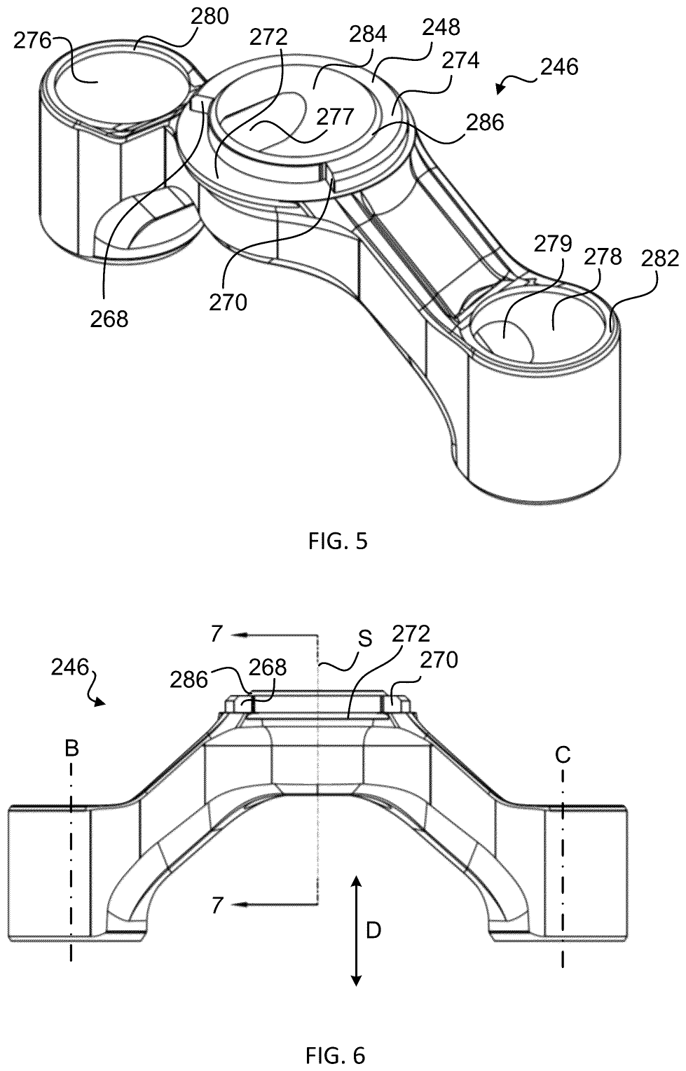

Turning now to FIG. 5, a perspective view of a crown 246 is provided. The crown 246 may be provided with various forks described herein, for example the front fork 108 of FIG. 2. It should also be appreciated that the features of the crown 246 may be applied to various other examples including single-leg fork arrangements, upside-down fork arrangements, and/or unitary crown and steerer arrangements.

The crown 246 shown in FIG. 5 includes a crown interface 248. The crown interface 248 generally is configured to facilitate relative rotation between the crown 248 and a frame or headset arrangement of a bicycle. For example, the crown interface 248 may be sized and shaped to directly contact a bearing of a headset assembly as described in further detail below. Alternatively, the crown interface 248 may be sized and shaped to retain a crown race (not shown) which in turn is configured to interface with a bearing element.

Still referring to FIG. 5, a stop body 274 is provided with the crown 246. The stop body 274 defines at least one rotational stop. The at least one rotational stop is configured to limit rotation of the crown 246 about the steering axis S. As shown in the example of FIG. 5, the stop body 274 defines a first rotational stop 268 and a second rotational stop 270. As will be described in greater detail below, the first rotational stop 268 and the second rotational stop 270 cooperate toward defining a range of rotational travel allowed by a steerer device.

A crown recess 272 is defined between the first rotational stop 268 and the second rotational stop. The crown recess 272 may in turn define a range of movement of a limiting feature of a steerer device between the first rotational stop 268 and the second rotational stop 270. For example, the crown recess 272 may be sized and shaped to allow free travel of a complimentary or reciprocal element fixed relative to a frame of a two-wheeled vehicle and the first rotational stop 268 and the second rotational stop 270 are each sized and shaped to impede further travel of such complimentary or reciprocal element.

The stop body 272 may be a separate, removable element from the crown 246. The stop body 272 may also be formed with or permanently, or semi-permanently, affixed to the crown 246, for example with adhesive, welding, brazing, or the like. In the example of FIG. 5, the stop body 272 is formed unitarily with the crown 246. For example, the stop body 272 may include machined features of the crown 246. The first rotational stop 268 and/or the second rotational stop 270 may be integrally formed with the crown 246, for example through such machining or composite forming processes.

As shown in FIG. 5, the crown 246 includes a steerer receiving feature 284. The steerer receiving feature 284 is shaped and sized to receive a steerer, for example the steerer 144 described above with reference to FIG. 2. Accordingly, the crown 246 of FIG. 5 is a separate element from a steerer and facilitates securing such a steerer through the steerer receiving feature 284.

Still referring to FIG. 5, the crown 246 includes at least one receiving feature configured to receive a fork leg element. As shown in the present example, a first receiving feature 276 and a second receiving feature 278 are provided on opposite sides of the steerer receiving feature 284. The first receiving feature 276 is sized and shaped to receive a portion of a first fork leg assembly and the second receiving feature 278 is sized and shaped to receive a portion of a second fork leg assembly. Accordingly, at least one end of at least one fork leg assembly terminates at the crown 246. An opposite end of the at least one fork leg assembly terminates at a wheel mounting interface as described elsewhere herein.

A first leg stop 280 is provided with the first receiving feature 276 and a second leg stop 282 is provided with the second receiving feature 278. The first leg stop 280 is configured to positively locate the first leg assembly terminating at the first receiving feature 276, for example by limiting movement past an installation position. The second leg stop 280 may be similarly shaped and sized so as to positively locate the second leg assembly terminating at the second receiving feature 278. It should be appreciated that further securing methods may be additionally or alternatively used, for example adhesive, welding, or unitary forming of the crown 246 and upper leg assemblies.

A first opening 277 is provided between the steerer receiving feature 284 and the first receiving feature 276 and a second opening 279 is provided between the steerer receiving feature 284 and the second receiving feature 278. The first opening 277 and the second opening 279 may be provided for weight reduction, fluid communication, and/or control cable, wire, or tube routing. In an example, at least one of the first opening 277 or the second opening 279 communicates an air volume from a corresponding fork leg assembly.

Turning now to FIG. 6, a centering feature 286 is also provided. In this embodiment, the centering feature 286 generally protrudes from the crown 246 in a direction D of the steering axis S and serves to center the crown 246 relative to a frame of the vehicle. The centering feature 286 as shown in FIG. 6 may be integrally formed with the crown 246, for example formed integrally with the stop body 274 and/or the crown interface 248. The centering feature 286 may also be provided on a separate piece, for example with a separate crown race feature. In the present example, the centering feature 286 is sized and shaped to interface with a corresponding feature of a cartridge bearing to facilitate centering and preloading of a headset arrangement as will be discussed in greater detail below.

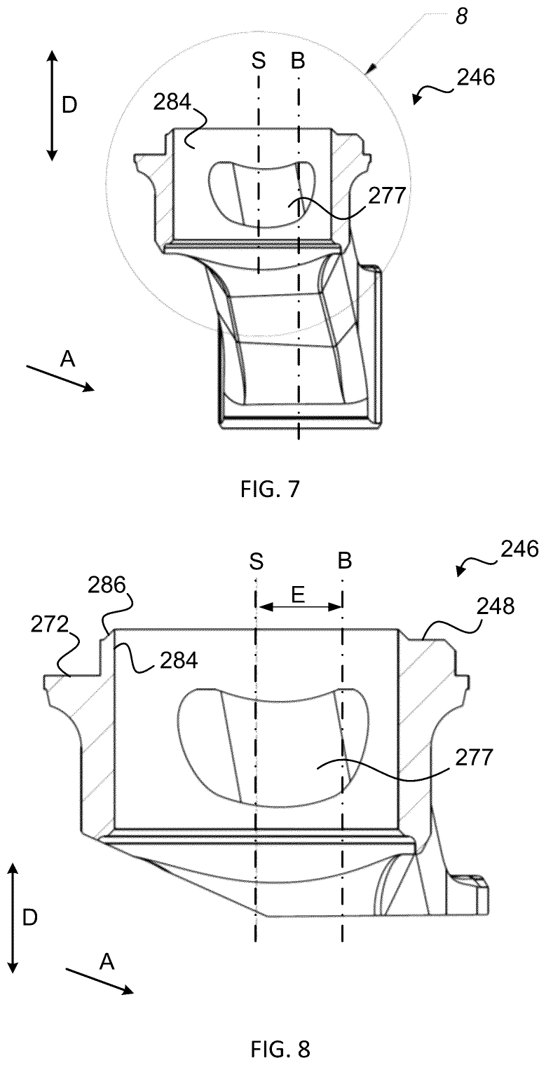

Turning now to FIG. 7, a sectional view of the crown 246 is provided. The steerer receiving feature 284 is shown partially interrupted by the first opening 277. In an embodiment, the steerer receiving feature 284 may be provided with adhesive or the like during installation to account for a reduction in contact area between the steerer receiving feature 284 and a steerer.

Turning now to FIG. 8, the enlarged view of the crown 246 as shown in FIG. 7 shows an angular arrangement of the centering feature 286 described above. In this configuration, the centering feature 286 may provide direct locating of a bearing, for example a cartridge bearing of a headset arrangement to provide accurate centering when preloaded. For example, the centering feature 286 may interface with a corresponding angled surface of a cartridge bearing to ensure concentricity therebetween. The centering feature 286 as described may thus provide concentricity between crown 246 and various other elements including a steerer, headset bearing, headtube opening in a frame, and/or a handlebar opening about the steering axis S.

Still referring to FIG. 8, the view shown is orthogonal to the direction of travel A with the crown 246 facing directly ahead, i.e. where a front wheel would be aligned forward in the direction of travel A. In this view, it can be seen that the steering axis S and the first leg axis B are parallel. However, it should also be appreciated that the first leg axis B may be non-parallel with the steering axis S, for example with the first leg axis B intersecting the steering axis S above the crown 246 in the direction D of the steering axis S and extending beyond the steering axis S in the forward direction A below the crown 246.

As shown in FIG. 8, an axis offset E may be defined between two or more axes. As shown, the first leg axis B and the steerer axis S are parallel. Although not shown, it should be appreciated that in this view the second leg axis C is parallel and overlapping with the first leg axis B. The axis offset E may be a tunable feature, for example to adjust mechanical trail of a two-wheeled vehicle. In examples where the steerer axis S and the first leg axis B are not parallel, an axis offset E may still be defined, for example taken at a defined point along the steering axis relative to the crown 246.

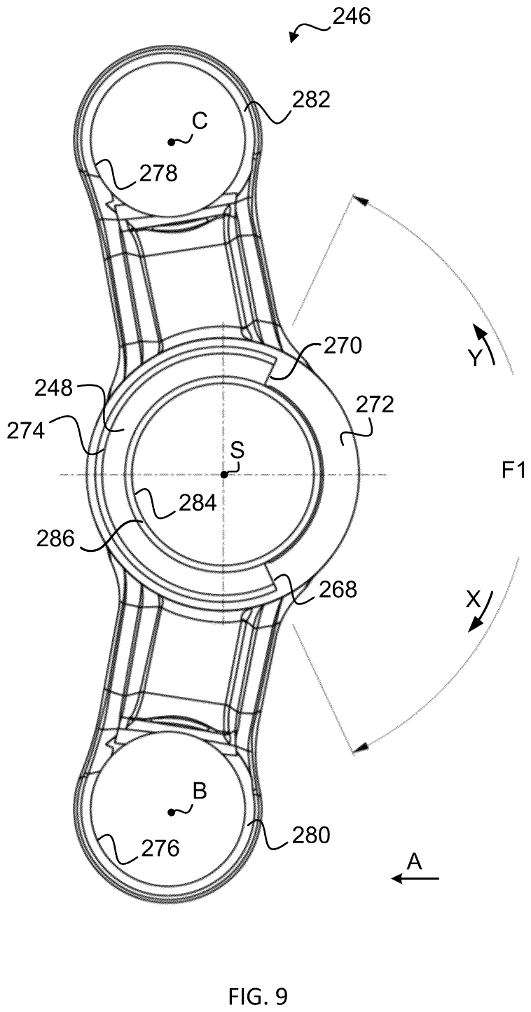

Turning now to FIG. 9, a top elevation view of the crown 246 shows further detail of the stop body 274 and the crown recess 272 defined between the first rotational stop 268 and the second rotational stop 270. The first rotational stop 268 defines a first maximum steering angle in a first direction X and the second rotational stop 270 defines a second maximum steering angle in a second direction Y. The first direction X and the second direction Y are defined as opposite rotational directions about the steering axis S. For example, the first direction X shown in the view of FIG. 9 is clockwise while the second direction Y is counterclockwise. In an example where a limiting feature of a steerer device engaging with the first rotational stop 268 and the second rotational stop 270 has no angular dimension, a first steering sweep F1 would define a maximum amount of angular steering travel. Given any angular dimension or thickness of such a limiting feature, the first steering sweep F1 would be reduced by this angular dimension or thickness to define an amount of angular sweep allowed by the steerer device. In various examples, the maximum steering sweep allowed by the steerer device may be between one hundred degrees (100°) and one hundred sixty degrees (160°). As will be described in greater detail below, the maximum steering sweep allowed by the steerer device may be tunable, for example by replacing one or more features of the steerer device.

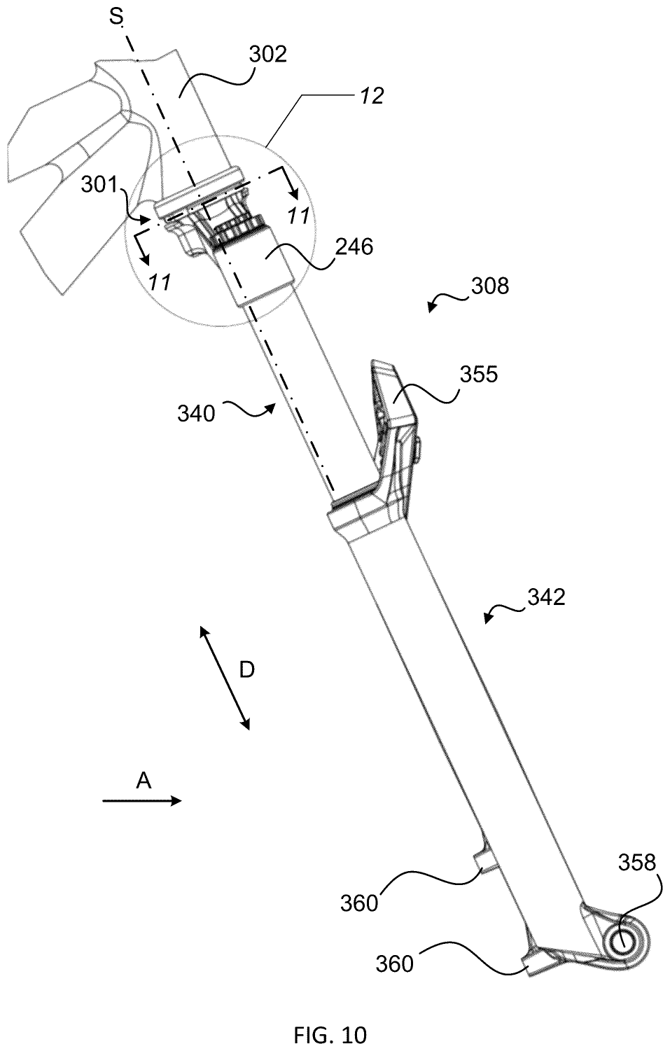

Turning now to FIG. 10, a suspension fork 308 is shown mounted to a frame 302 of a bicycle. Although not shown, a steerer extends from the fork 308 in the direction D at least partially through the frame 302. A handlebar, for example as shown in FIG. 1, may be attached to the fork 308, for example through the steerer. At an opposing end of the suspension fork 308, a wheel mounting interface 358 is provided. A brake mounting interface 360 is also provided in FIG. 10. The features of the suspension fork 308, including the brake mounting interface 360 and the wheel mounting interface 358 may generally correspond to related features in other examples described herein. As shown, a fork lower 342 is connected to a fork upper 340 via a telescopic arrangement. As described elsewhere herein, such a telescopic arrangement may include various spring and damper configurations. A leg brace 355 is also provided, here shown between legs of the fork lower 342.

Still referring to FIG. 10, a steerer device 301 is provided. The steerer device 301 may generally control or limit relative movement between the frame 302 and the fork 308. For example, the steerer device 301 may limit rotation of the fork 308 relative to the frame 302. As can be seen in FIG. 10, it is conceivable that at least a portion of the crown 246 would impact the frame 302 if the steerer device 301 did not limit rotation of the fork 308. Additionally or alternatively, external or internal control cable elements may be damaged or a handlebar may impact the frame 302 if the steerer device 301 did not appropriately limit rotation of the fork 308.

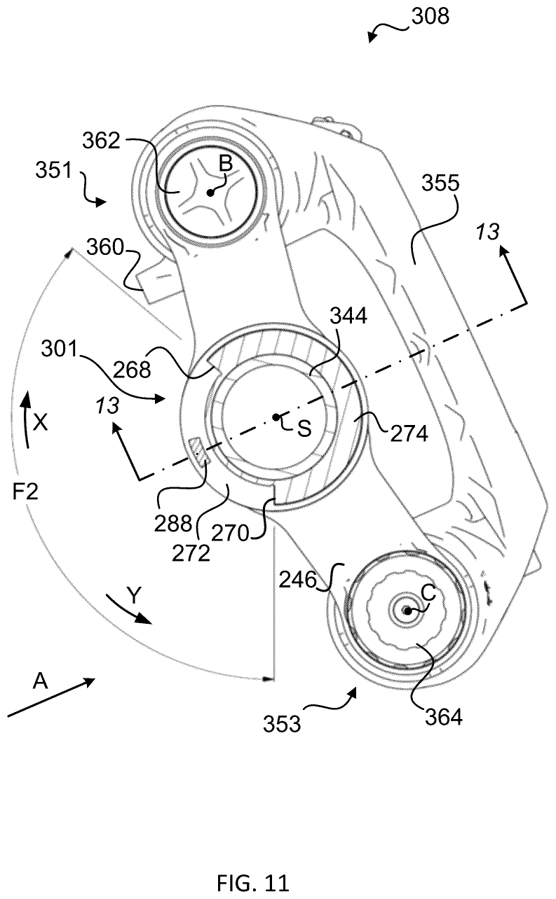

Turning now to FIG. 11, a sectional view of the suspension fork 308 of FIG. 10 is shown as indicated by cut-line 11-11 in FIG. 10. The view of FIG. 11 shows a limiting feature 288 of the steerer device extending from the frame 302 towards the fork 308. Specifically, the limiting feature 288 extends into the crown recess 272 between the first rotational stop 268 and the second rotational stop 270 of the stop body 274. With the limiting feature 288, a second steering sweep F2 is defined, reduced from the first steering sweep F1 described above by an angular dimension of the limiting feature 288. Accordingly, the second steering sweep F2 defines a maximum steering sweep of the fork 308 relative to the frame 302.

As shown in FIG. 11, the steerer device 301 includes at least one element, for example the limiting feature 288, rotatably fixed or fixable with the frame 302. As will be described in greater detail below, the limiting feature 288 may be a headset element or a portion of a headset element extending from the frame 302 towards the fork 308. The limiting feature 288, defining the second steering sweep F2, is configured to engage with at least one rotational stop and thereby define at least one maximum steering angle. For example, the limiting feature 288 shown in FIG. 11 is shaped and sized to interface with the first rotational stop 268 and oppositely with the second rotational stop 270 with the steering sweep defined between positions corresponding to those engagements.

Also shown in FIG. 11 is a steerer 344 installed with the crown 246. As described elsewhere herein, the steerer 344 may be press fit into the crown 246, cryogenically installed, and/or adhesively mounted. It should be appreciated that the interface between the stop body 274 and the limiting feature 288 allows direct transmission of force from the crown 246 to the limiting feature 288 attached to the frame 302. Accordingly, wheel impacts transmit force at the extreme rotational positions to the frame through the crown 246 but not through the steerer 344. This preferential force transmission through the crown 246 relieves the connection between the steerer 344 and the crown 246 of potentially high forces at these extreme rotational positions defined at the ends of the second steering sweep F2.

Still referring to FIG. 11, a first leg assembly 351 is provided opposite a second leg assembly 353. The first leg assembly 351 includes a spring interface 362 and the second leg assembly 353 includes a damper interface 364. However, it should be appreciated that various spring and damper elements may be contained in only one of or both the first leg assembly 351 and the second leg assembly 353.

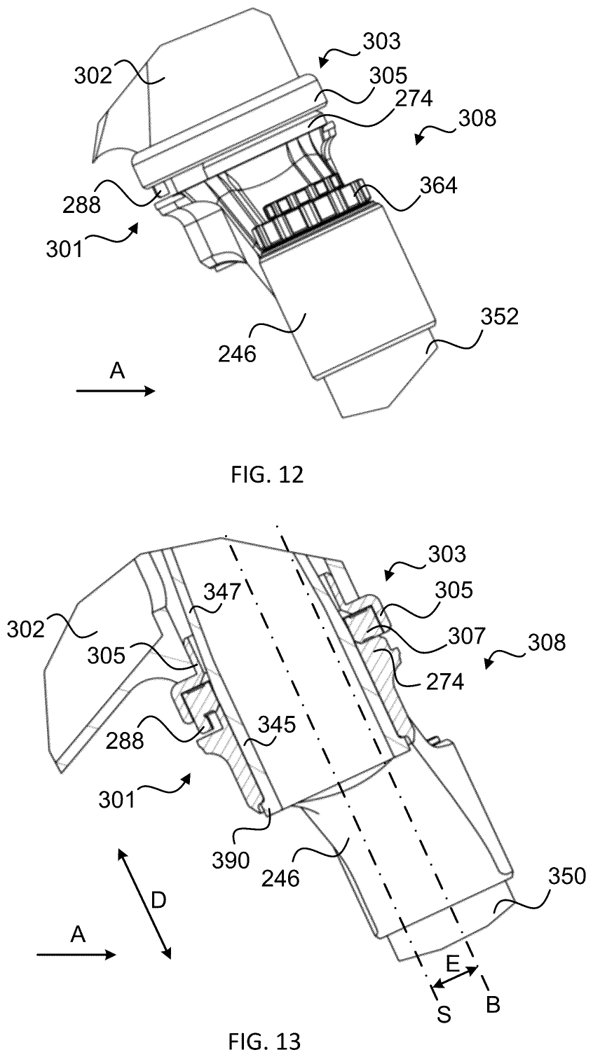

Turning now to FIG. 12, a partial side view of the steerer device 301 is shown. A headset assembly 303 is provided with the frame 302. As described above, the headset assembly 303 may generally facilitate rotation of the fork 308 relative to the frame 302. In the present example, the limiting feature 288 can be seen extending from the headset assembly 303. The limiting feature 288 may for example be a protrusion extending at least in part in the direction D of the steering axis S towards the crown recess 277.

The example of FIG. 12 provides a headset body 305 with the headset assembly 303. In this example, the headset body 305 is provided as a removable element, also referred to as an external headset cup. However, it should also be appreciated that the headset body 305 may be integral with the frame 302. For example, the headset body 305 may be formed within a composite structure of the frame 302.

Turning now to FIG. 13, a sectional view taken along cut line 13-13 in FIG. 11 and generally corresponding to a cross-section of the side view of FIG. 12 is provided. As shown in FIG. 13, the steerer 344 installed within the crown 246 includes a steerer lower portion 345 and a steerer transition portion 347. The steerer lower portion 345 as shown has a consistent outer dimension along the steering axis S at least for the corresponding portion of the crown 246 overlapping in the direction D. In an example, the steerer lower portion 345 maintains a constant outer diameter for an entire extent of the crown 246 and at least a portion of the headset assembly 303 in the direction D. As shown in the example of FIG. 13, the steerer lower portion 345 continues to provide a consistent outer diameter for retention and centering of a headset bearing 307 of the headset assembly 303. The headset bearing 307 may be a cartridge bearing such as a ball bearing or roller bearing retained and/or located in the headset body 305.

Still referring to FIG. 13, the steerer lower portion 345 includes a steerer locating element 390. The steerer locating element 390 serves to positively locate the steerer lower portion 345 relative to the crown 246. As shown, the steerer locating element 390 is a flange or lip sized and shaped to interface with a limiting feature of the crown 246. However, the steerer locating element 390 may be formed in various other configurations or omitted. The steerer lower portion 345 may be adhesively or otherwise secured within the crown 246 as described elsewhere herein.

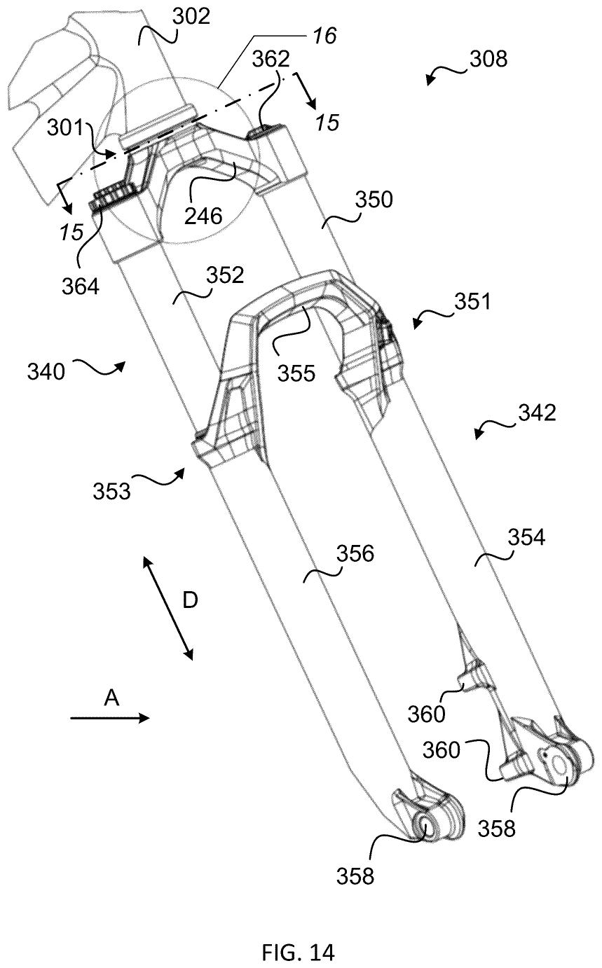

Turning now to FIG. 14, a perspective view of the fork 308 is provided in a rotated position. As will be described in greater detail below, the rotated position of the fork 308 in FIG. 14 may be referred to as a maximum rotational position, maximum steering angle, or an extreme position. The steerer device 301 generally controls the maximal rotational position as shown in FIG. 14, for example through interaction of the limiting feature 288 and first rotational stop 268 shown in FIG. 11.

Also shown in FIG. 14, the first leg assembly 351 includes a right side up telescopic arrangement of a first upper leg 350 within a first lower leg 354 and the second leg assembly 353 includes a right side up telescopic arrangement of a second upper leg 352 within a second lower leg 356. The first leg assembly 351 is rotated in front of the second leg assembly 353 in the forward direction A, for example by a handlebar assembly as shown in FIG. 1.

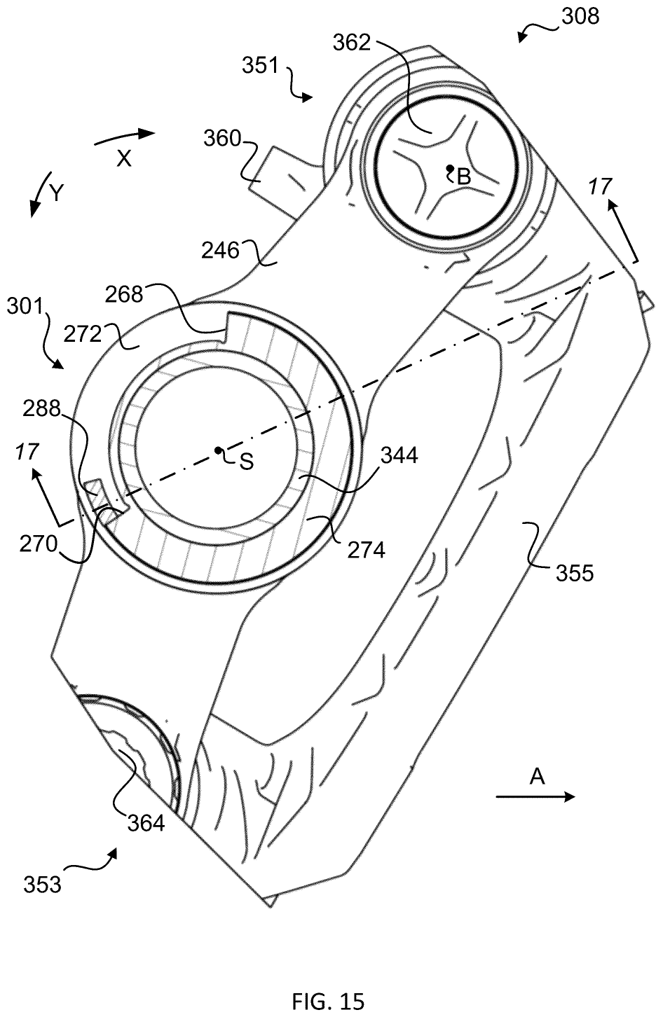

Turning now to FIG. 15, a sectional view looking down the steering axis S is provided as indicated by cut line 15-15 in FIG. 14. As shown in FIG. 15, the limiting feature 288 contacts the second rotational stop 270. This contact of the second rotational stop 270 defines a second maximum rotation, opposite from a first maximum rotation defined by similar contact between the limiting feature 288 and the first rotational stop 268.

The example of FIG. 15 demonstrates how forces from the wheel about the steering axis S can be transmitted directly through the crown 246 to the limiting feature 288. That is, a load path may be defined between the crown 246 and the limiting feature 288 or other frame or headset element, wherein the load path does not include the steerer 344. Alternatively defined, a load path defined between the stop body 274, including the first rotational stop 268 and/or the second rotational stop 270, includes the crown 246. That is, rotational forces about the steering axis S transmitted between the one of the rotational stops 268, 270 and the steerer 344 must pass through the crown 246. With the described arrangement, undue stress between the crown 246 and the steerer 344 can thus be avoided.

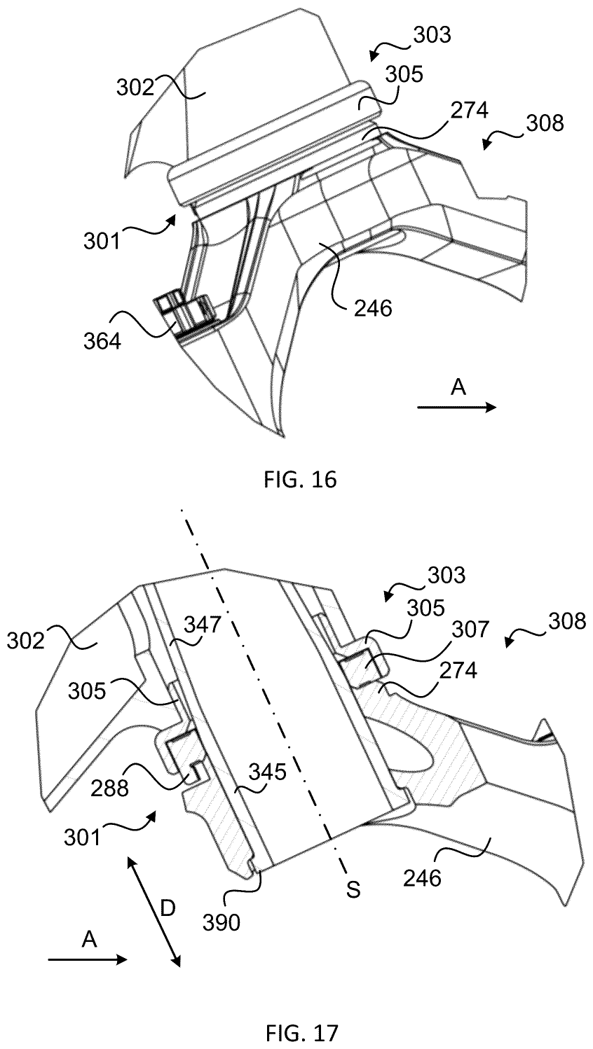

Turning now to FIG. 16, an enlarged view of the rotated steerer device 301 is provided as indicated by callout 16 in FIG. 14. As shown in FIG. 16, at least a portion of the stop body 274 may be exposed in the depicted installed state. The stop body 274 may at least in part serve as a shield and/or seal, for example to protect bearings or other lubricated clean elements of the headset assembly 303.

Turning now to FIG. 17, a sectional view generally corresponding to a cross-section of FIG. 16 and indicated by cut line 17-17 in FIG. 15 is provided. As described above, the steerer of FIG. 17 may be retained within the crown 246 in various ways, including through the steerer locating element 390. The steerer locating element 390 may also facilitate use of the headset assembly 303, for example to enable secure preloading of the headset bearing 307 via a tensioning force on the steerer 344 in the direction D along the steering axis S.

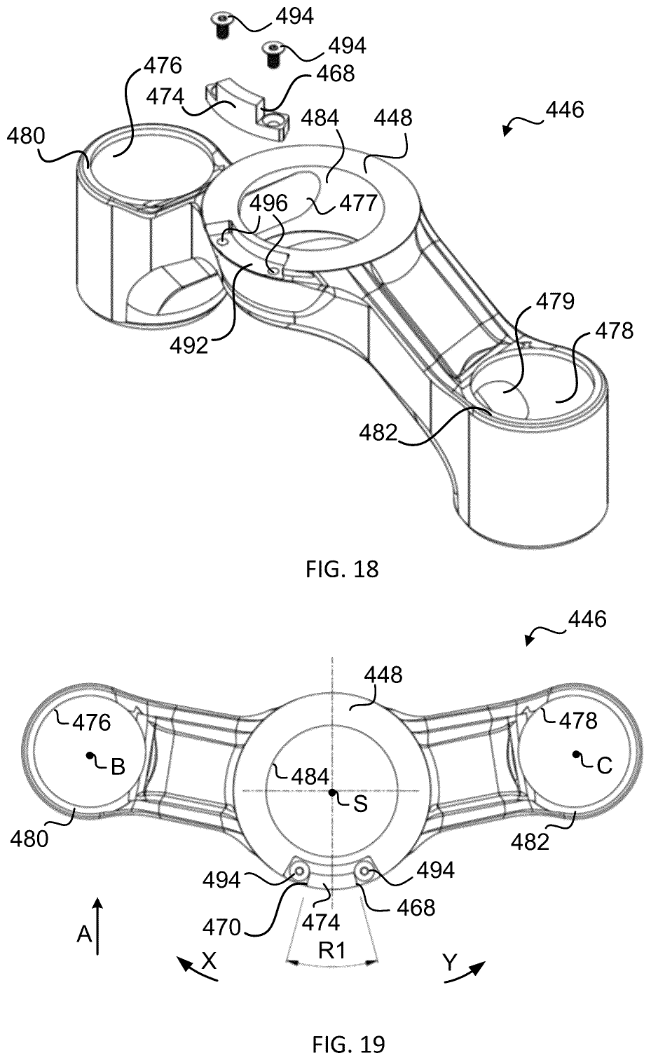

Turning now to FIG. 18, an example of a crown 446 for use in various examples of steerer device, fork, and frame described herein is provided. The crown 446 includes a stop body 474. The stop body 474 as shown is removable from the crown 446, but may be permanently or semi-permanently affixed. The stop body 474 as shown protrudes above the crown, for example to provide one or more protruding surfaces to interact with a corresponding element of a steerer device as will be described in greater detail below.

Still referring to FIG. 18, the crown 446 further includes a crown interface 448. The crown interface 448 and other elements in the present example related to elements in other examples herein may generally share common features. The present example however provides the stop body 474 including at least a first rotational stop 468 protruding from the crown interface 448. As described just above, the first rotational stop 468 may be removed from the crown 446, for example through use of one or more of a fastener 494. In FIG. 18, two of the fastener 494 are provided for securing the stop body 474 to the crown with corresponding fastener openings 496. The fastener openings 496 may be threaded bores or any other suitable fastening arrangement including clips and recesses.

The example of FIG. 18 further depicts a receiving recess 492. The receiving recess 492 is sized and shaped for receiving the stop body 474. In the present example, the receiving recess 492 incudes the fastener openings 496. It should be appreciated, however, that the fastener openings 496 may be located outside of the receiving recess 492 or excluded altogether. For example, the stop body 474 may be press fit and/or adhesively retained within the receiving recess 492. In another example, the receiving recess 492 is omitted and the stop body 474 is integrally formed with the crown 446, for example through a forging, machining, or composite process.

FIG. 18 also shows a first opening 477 and a second opening 479. The first opening 477 and the second opening 479 may be provided for lightweighting, for example through a machining process. Additionally or alternatively, at least one of the first opening 477 or the second opening 479 may be provided to contain a volume of air, for example a positive air volume for an air spring.

Turning now to FIG. 19, a top view of the crown 446 of FIG. 19 is provided. As shown in FIG. 19, a first receiving feature 476 is provided opposite a second receiving feature 478 across a steering receiving feature 484 centered about the steering axis S. The first receiving feature 476 is generally shaped and sized to receive a first fork upper leg and a top cap assembly, for example including a spring interface. The second receiving feature 478 is generally shaped and sized to receive a second fork upper leg and a top cap assembly, for example including a damper interface. The steerer receiving feature 484 is generally shaped and sized to receive a steerer, for example a steerer lower portion about the steering axis S such that the steerer and the crown 446 are rotationally fixed relative to one another.

The example of FIG. 19 further provides a first leg stop 480 and a second leg stop 482. The first leg stop 480 is provided for locating at least one of a first fork leg assembly or a first leg top cap assembly. The second leg stop 482 is provided for locating at least one of a second fork leg assembly or a second leg top cap assembly. In an example, the first leg stop 480 positively locates a first fork leg assembly relative to a spring interface and the second leg stop 482 positively locates a second fork leg assembly relative to a damper interface.

As shown in FIG. 18, the stop body 474 includes at least the first rotational stop 468. FIG. 19 shows that opposite the first rotational stop 468, the stop body 474 includes a second rotational stop 470. An angular extent of the stop body 474, also referred to as a protrusion or protrusion element, may be defined as a rotational extent R1 shown in FIG. 19. As with the example of FIG. 11 wherein a width of the limiting feature 288 contributes to a defined maximum steering angle, the rotational extent R1 may contribute to defining such a controlled maximum steering angle. For example, the rotational extent R1 may be constrained within a headset feature rotationally fixed relative to a frame and generally corresponding to the shape and size of the stop body 274 of the example of FIG. 11.

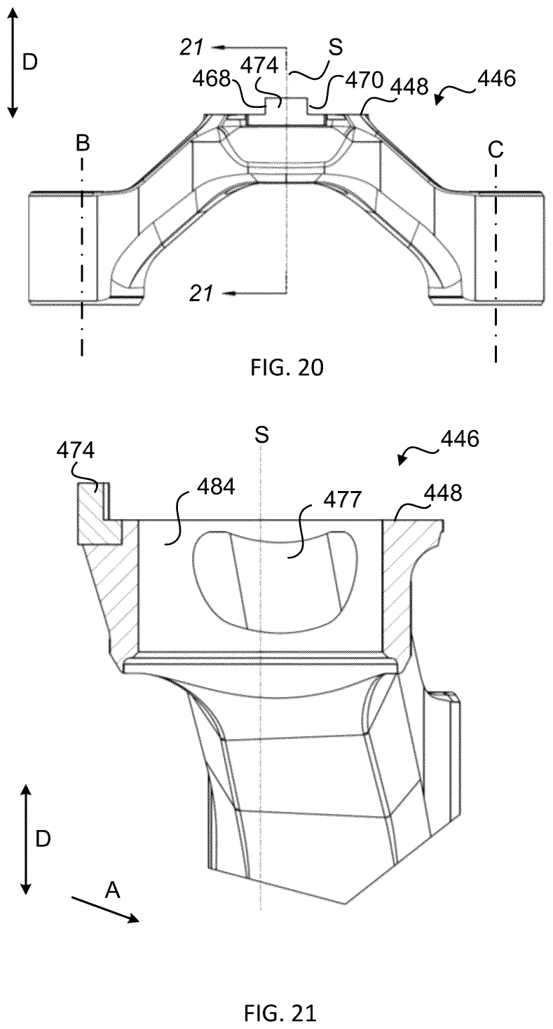

Turning now to FIG. 20, a rear view of the crown 446 is provided. As shown in FIG. 20, the stop body 474 protrudes along the steering axis S in the direction D from the crown interface 448. The stop body 474, the first rotational stop 468, and the second rotational stop 470 are sized and shaped to interface with at least one complimentary limiting element to limit rotation of the crown 446 about the steering axis S. For example, the stop body 474 may interface with a complimentary limiting element sized and shaped as the stop body 274 of FIG. 11. In this example, the stop body 474 is fixed on the crown 446 and the stop body 274 is fixed on the frame, for example through the headset assembly. Accordingly, interaction between the stop body 274 and the stop body 474 in this example can control a maximum relative rotation between the frame and the crown 446.

Turning now to FIG. 21, a sectional view of the crown 446 is provided as viewed along cut line 21-21 from FIG. 20. As shown in FIG. 21, the stop body 474 and corresponding rotational stop feature(s) include a protrusion extending at least in part in the direction D of the steering axis S. As described above with reference to FIG. 20, this protrusion may extend toward at least one limiting feature, for example of a frame and/or headset assembly. The limiting feature may be formed as a recess as described above or in any other suitable manner, for example as one or more corresponding protrusions shaped and sized to interface with the stop body 474.

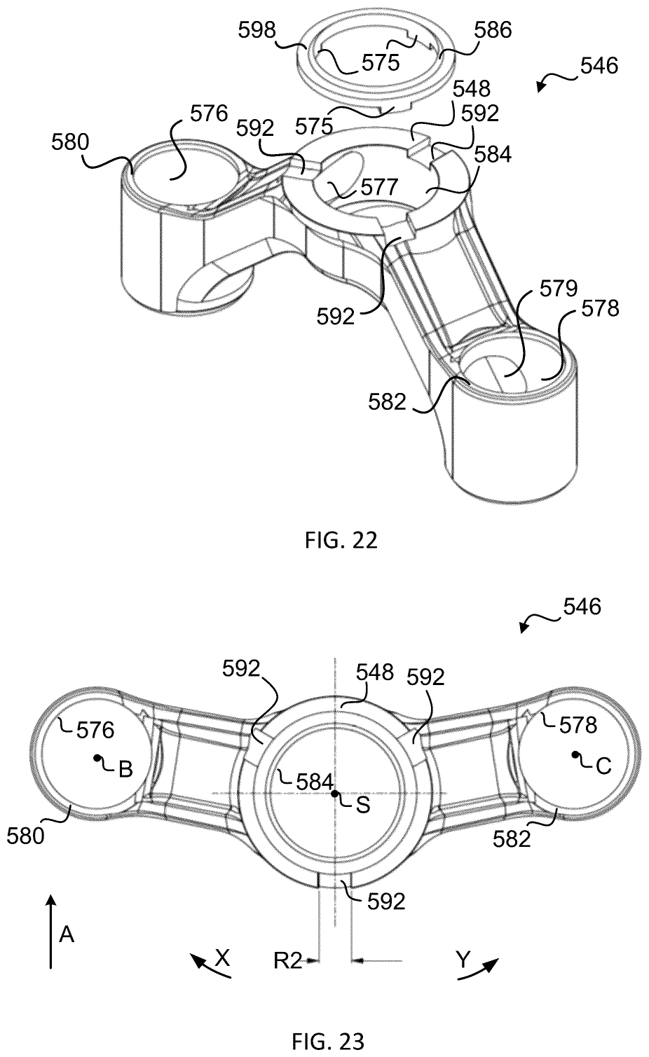

Turning now to FIG. 22, a crown 546 is provided to interact with various fork, frame, and steerer device arrangements described herein. The crown 546 includes a crown interface 548 adapted to receive at least one ring element 598. One or more of a receiving recess 592 is provided in the crown interface 548, the receiving recess(es) 592 shaped and sized to receive and/or retain one or more corresponding engagement features 575 of the ring element 598. A plurality of the engagement features 575 may directly correspond with a plurality of the receiving recesses. In the example of FIG. 22, three of the receiving recesses 592 are evenly spaced apart about the steering axis S on the crown interface 548. Correspondingly, three of the engagement features 575 are spaced apart about the steering axis S on the ring element 598.

As shown in FIG. 22, the ring element 598 may be provided without any stop body or rotational stops. For example, the ring element 598 shown in FIG. 22 may be supplied to ensure compatibility with frame or headset assemblies not configured to accept rotational stop features. However, if a user has a compatible frame or headset assembly, they may install replacement element instead of the depicted ring element 598 having a stop body. In this way, the steerer device can retain compatibility with previous generations of frame and fork design while still enabling beneficial crown-based rotational stops. For example, the ring element 598 may be replaced by a protruding configuration as described with reference to FIGS. 18-21 or by a recess configuration as described with reference to FIGS. 5-17.

Still referring to FIG. 22, various other elements are provided generally corresponding with the description of related elements elsewhere herein. For example, a first opening 577 and a second opening 579 are provided. These elements may be configured with any suitable arrangement of related elements in this description.

Turning now to FIG. 23, a top view of the crown 546 of FIG. 22 is provided. A steerer receiving feature 584 is provided between a first receiving feature 576 and a second receiving feature 578. A first leg stop 580 is associated with the first receiving feature 576 and a second leg stop 582 is associated with the second receiving feature 578.

In FIG. 23, a recess width R2 is defined. The recess width R2 may be the same for each of the provided receiving recesses 592 or may be variable. In an example, the recess width R2 is provided to accommodate stop body such as the stop body 474 described above with reference to FIGS. 18-21. Additionally or alternatively, the recess width R2 may be sized and shaped to allow crown tool access, for example as with the crown tool access 166 described above with reference to FIG. 4.

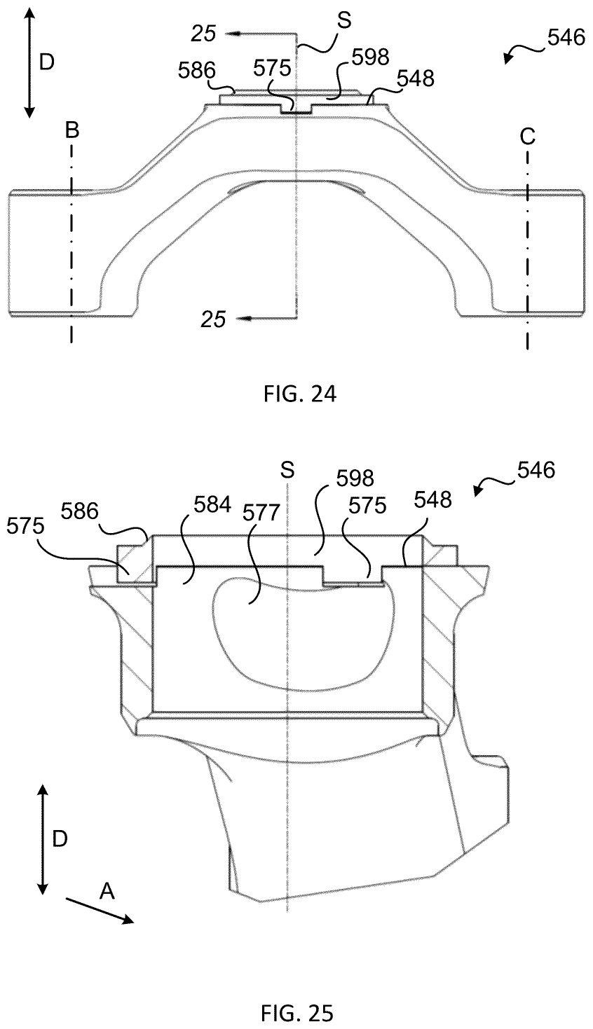

Turning now to FIG. 24, a rear view of the crown 546 is provided. As can be seen in FIG. 24, the ring element 598 may be configured at least in part as a bearing interface. For example, the ring element 598 may include a centering feature 586 as described below for bearing interface. The ring element 598, whether with a rotational stop or not, may directly or indirectly interface with a bearing of a headset assembly as described elsewhere herein.

Turning now to FIG. 25, the centering feature 586 of the ring element 598 can be seen in greater detail. The centering feature 586 is shaped and sized to retain a corresponding surface of a headset bearing, for example a cartridge bearing as described above.

Also shown in FIG. 25, the engagement features 575 can be seen in greater detail. The engagement features 575 may be shaped and sized to retain the ring element 598 on the crown 546. For example, the engagement features 575 may cooperate with the receiving recesses 592 to retain the ring element 598 at least in a radial direction of the steering axis S. Additionally or alternatively, the engagement features 575 may provide an interference fit with the crown 546.

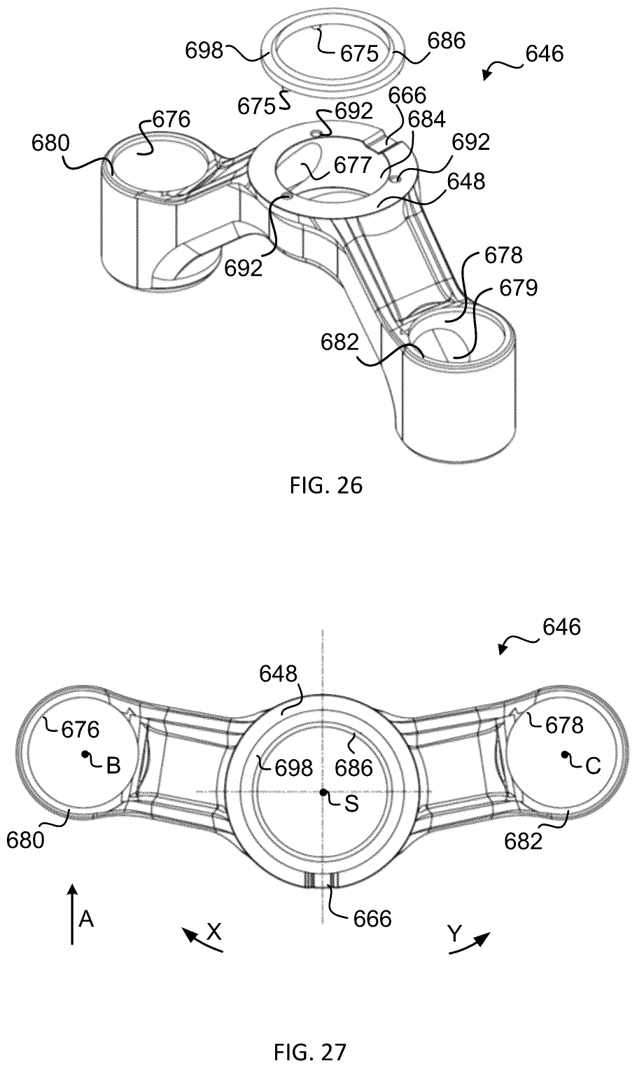

Turning now to FIG. 26, 646 is provided to interact with various fork, frame, and steerer device arrangements described herein. The crown 646 includes a crown interface 648 adapted to receive at least one ring element 698. One or more of a receiving opening 692 is provided in the crown interface 648, the receiving opening(s) 592 shaped and sized to receive and/or retain one or more corresponding engagement features 675 of the ring element 698. A plurality of the engagement features 675 may directly correspond with a plurality of the receiving recesses. In the example of FIG. 26, three of the receiving openings 692 are evenly spaced apart about the steering axis S on the crown interface 648. Correspondingly, three of the engagement features 675 are spaced apart about the steering axis S on the ring element 698.

As shown in FIG. 26, the ring element 698 may be provided without any stop body or rotational stops. For example, the ring element 698 shown in FIG. 26 may be supplied to ensure compatibility with frame or headset assemblies not configured to accept rotational stop features. However, if a user has a compatible frame or headset assembly, they may install an ring element 698 having a stop body. In this way, the steerer device can retain compatibility with previous generations of frame and fork design while still enabling beneficial crown-based rotational stops. For example, the ring element 698 may be replaced by a protruding configuration as described with reference to FIGS. 18-21 or by a recess configuration as described with reference to FIGS. 5-17.

Still referring to FIG. 26, various other elements are provided generally corresponding with the description of related elements elsewhere herein. For example, a first opening 677 and a second opening 679 are provided. These elements may be configured with any suitable arrangement of related elements in this description.

Turning now to FIG. 27, a top view of the crown 646 of FIG. 22 is provided. A steerer receiving feature 684 is provided between a first receiving feature 676 and a second receiving feature 678. A first leg stop 680 is associated with the first receiving feature 676 and a second leg stop 682 is associated with the second receiving feature 678.

In FIG. 27, a crown tool access 666 is provided. As described above, the crown tool access 666 may facilitate removal of an element such as a crown race with a prying tool such as a flat bladed screwdriver. The crown tool access 666 may also be used to remove the ring element 698, for example in embodiments where the engagement feature(s) 675 is/are press fit into the receiving opening(s) 692.

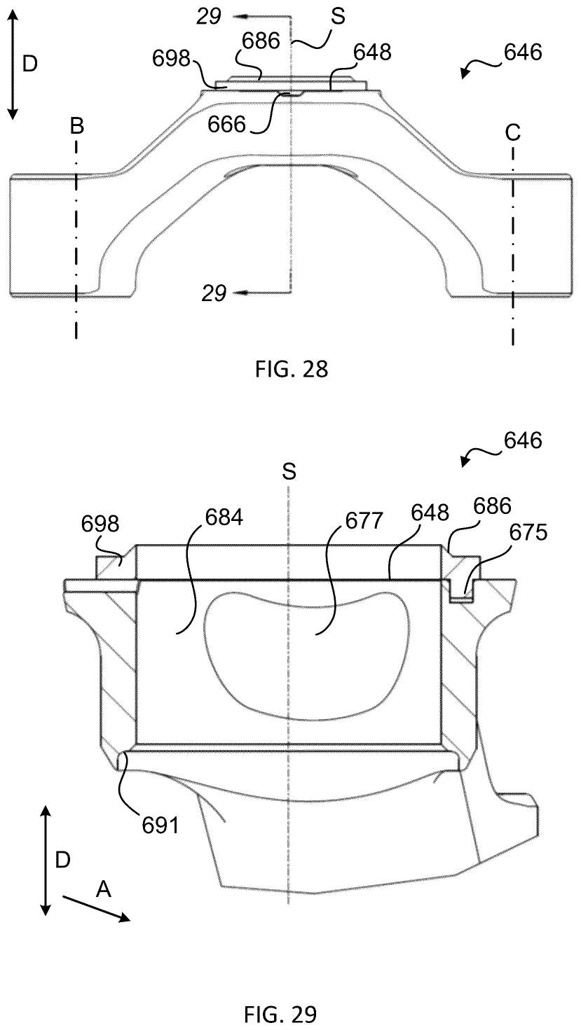

Turning now to FIG. 28, a rear view of the crown 646 is provided. As can be seen in FIG. 28, the ring element 698 may be configured at least in part as a bearing interface. For example, the ring element 698 may include a centering feature 686 as described below for bearing interface. The ring element 698, whether with a rotational stop or not, may directly or indirectly interface with a bearing of a headset assembly as described elsewhere herein.

Turning now to FIG. 29, the centering feature 686 of the ring element 698 can be seen in greater detail. The centering feature 686 is shaped and sized to retain a corresponding surface of a headset bearing, for example a cartridge bearing as described above.

Also shown in FIG. 29, the engagement features 675 can be seen in greater detail. The engagement features 675 may be shaped and sized to retain the ring element 698 on the crown 646. For example, the engagement features 675 may cooperate with the receiving openings 692 to retain the ring element 698 at least in a radial direction of the steering axis S. Additionally or alternatively, the engagement features 675 may provide an interference fit with the crown 646.

FIG. 29 further provides a steerer retention feature 691 that may be employed with various other arrangements described herein. As shown, the steerer retention feature 691 is shaped and sized to receive a complimentary steerer feature, for example the steerer locating element 390 described above with reference to FIG. 13. In FIG. 29, the steerer retention feature 691 is directly formed into the body of the crown 646, for example through molding or machining processes. However, the steerer retention feature 691 may be a separate element in various other examples.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this depiction should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

Any Abstract of the Disclosure provided herein is submitted with the understanding that it will not be used to interpret or limit the scope or meaning of the claims. In addition, in the foregoing Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to fewer than all of the features of any of the disclosed embodiments. Thus, the following claims are incorporated into the Description, with each claim standing on its own as defining separately claimed subject matter.

It is intended that the foregoing Description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Further aspects are provided by the subject matter of the following clauses:

A steerer device for a two-wheeled vehicle, the steerer device comprising: a steerer adaptable for handlebar control and rotatable about a steering axis; at least one fork leg assembly, the at least one fork leg assembly including a wheel mounting interface; a crown connecting the steerer and the at least one fork leg assembly; and at least one rotational stop fixed on the crown, the at least one rotational stop sized and shaped to limit rotation of the crown about the steering axis.

The steerer device of the preceding clause, wherein the at least one rotational stop is integrally formed with the crown.

The steerer device of any of the preceding clauses, wherein the steerer and the crown are separate elements and wherein the steerer is secured within the crown.

The steerer device of any of the preceding clauses, wherein a load path defined between the at least one rotational stop and the steerer includes the crown.

The steerer device of any of the preceding clauses, wherein the at least one rotational stop includes a protrusion from a crown interface of the crown.

The steerer device of any of the preceding clauses, wherein the at least one rotational stop includes a protrusion extending at least in part in a direction of the steering axis.

The steerer device of any of the preceding clauses, wherein the at least one rotational stop is removable from the crown.

The steerer device of any of the preceding clauses, wherein the at least one rotational stop comprises: a first rotational stop defining a first maximum steering angle; and a second rotational stop spaced apart from the first rotational stop and defining a second maximum steering angle.

The steerer device of any of the preceding clauses, wherein a maximum steering sweep defined between the first maximum steering angle and the second maximum steering angle is within a range of between one hundred degrees (100°) and one hundred sixty degrees (160°).

The steerer device of any of the preceding clauses, further comprising a headset element torsionally fixable with a bicycle frame, the headset element comprising at least one limiting feature to engage with the at least one rotational stop and thereby define at least one maximum steering angle.

The steerer device of any of the preceding clauses, wherein the at least one limiting feature is a protrusion extending at least in part in a direction of the steering axis towards the at least one rotational stop, the at least one rotational stop comprising a recess.

The steerer device of any of the preceding clauses, wherein the at least one rotational stop is a protrusion extending at least in part in a direction of the steering axis towards the at least one limiting feature, the at least one limiting feature comprising a recess.

The steerer device of any of the preceding clauses, wherein the steerer comprises: a steerer lower portion passing through the crown; and a steerer upper portion sized and shaped to receive at least one of a handlebar or a handlebar stem.

A suspension fork for a two-wheeled vehicle, the suspension fork comprising: a steerer adaptable for handlebar control and rotatable about a steering axis; at least one fork leg assembly, the at least one fork leg assembly including a wheel mounting interface; a crown connecting the steerer and the at least one fork leg assembly; and at least one rotational stop fixed on the crown, the at least one rotational stop sized and shaped to limit rotation of the crown about the steering axis.

The suspension fork of the preceding clause, wherein the at least one fork leg assembly comprises: a first end including the wheel mounting interface; and a second end opposite the first end, the second end terminating at the crown.

The suspension fork of any of the preceding clauses, wherein the at least one fork leg assembly comprises: a first leg assembly extending between the crown and the wheel mounting interface along a first leg axis; and a second leg assembly spaced apart from the first leg assembly and extending between the crown and the wheel mounting interface along a second leg axis.

The suspension fork of any of the preceding clauses, wherein the first leg assembly comprises: a first lower leg including at least a portion of the wheel mounting interface; and a first upper leg terminating at a first receiving feature in the crown and telescopically connected with the first lower leg along the first leg axis; and wherein the second leg assembly comprises: a second lower leg including at least a portion of the wheel mounting interface; and a second upper leg terminating at a second receiving feature in the crown and telescopically connected with the second lower leg along the second leg axis.

The suspension fork of any of the preceding clauses, further comprising a damper interface disposed on the crown, the damper interface to facilitate user adjustment of at least one damper characteristic.

The suspension fork of any of the preceding clauses, further comprising a spring interface disposed on the crown opposite the damper interface, the spring interface to facilitate user adjustment of at least one spring characteristic.

A suspension fork for a two-wheeled vehicle, the suspension fork comprising: a steerer adaptable for handlebar control and rotatable about a steering axis; at least one fork leg assembly, the at least one fork leg assembly including a wheel mounting interface; a crown connecting the steerer and the at least one fork leg assembly; and at least one rotational stop fixed on the crown, the at least one rotational stop sized and shaped to interface with a limiting feature to limit rotation of the crown about the steering axis.

We claim:

1. A steerer device for a two-wheeled vehicle, the steerer device comprising:
a steerer adaptable for handlebar control and rotatable about a steering axis;
at least one fork leg assembly, the at least one fork leg assembly including a wheel mounting interface;
a crown connecting the steerer and the at least one fork leg assembly; and
at least one rotational stop fixed on the crown, the at least one rotational stop sized and shaped to limit rotation of the crown about the steering axis.

2. The steerer device of claim 1, wherein the at least one rotational stop is integrally formed with the crown.

3. The steerer device of claim 1, wherein the steerer and the crown are separate elements and wherein the steerer is secured within the crown.

4. The steerer device of claim 3, wherein a load path defined between the at least one rotational stop and the steerer includes the crown.

5. The steerer device of claim 1, wherein the at least one rotational stop includes a protrusion from a crown interface of the crown.

6. The steerer device of claim 1, wherein the at least one rotational stop includes a protrusion extending at least in part in a direction of the steering axis.

7. The steerer device of claim 1, wherein the at least one rotational stop is removable from the crown.

8. The steerer device of claim 7, wherein the at least one rotational stop comprises:
a first rotational stop defining a first maximum steering angle; and
a second rotational stop spaced apart from the first rotational stop and defining a second maximum steering angle.

9. The steerer device of claim 8, wherein a maximum steering sweep defined between the first maximum steering angle and the second maximum steering angle is within a range of between one hundred degrees (100°) and one hundred sixty degrees) (160°).

10. The steerer device of claim 1, further comprising a headset element torsionally fixable with a bicycle frame, the headset element comprising at least one limiting feature to engage with the at least one rotational stop and thereby define at least one maximum steering angle.

11. The steerer device of claim 10, wherein the at least one limiting feature is a protrusion extending at least in part in a direction of the steering axis towards the at least one rotational stop, the at least one rotational stop comprising a recess.

12. The steerer device of claim 10, wherein the at least one rotational stop is a protrusion extending at least in part in a direction of the steering axis towards the at least one limiting feature, the at least one limiting feature comprising a recess.

13. The steerer device of claim 1, wherein the steerer comprises:
a steerer lower portion passing through the crown; and
a steerer upper portion sized and shaped to receive at least one of a handlebar or a handlebar stem.

14. A suspension fork for a two-wheeled vehicle, the suspension fork comprising:
a steerer adaptable for handlebar control and rotatable about a steering axis;
at least one fork leg assembly, the at least one fork leg assembly including a wheel mounting interface;
a crown connecting the steerer and the at least one fork leg assembly; and
at least one rotational stop fixed on the crown, the at least one rotational stop sized and shaped to limit rotation of the crown about the steering axis.

15. The suspension fork of claim 14, wherein the at least one fork leg assembly comprises:
a first end including the wheel mounting interface; and
a second end opposite the first end, the second end terminating at the crown.

16. The suspension fork of claim 14, wherein the at least one fork leg assembly comprises:
a first leg assembly extending between the crown and the wheel mounting interface along a first leg axis; and
a second leg assembly spaced apart from the first leg assembly and extending between the crown and the wheel mounting interface along a second leg axis.

17. The suspension fork of claim 16, wherein the first leg assembly comprises:
a first lower leg including at least a portion of the wheel mounting interface; and
a first upper leg terminating at a first receiving feature in the crown and telescopically connected with the first lower leg along the first leg axis; and
wherein the second leg assembly comprises:
a second lower leg including at least a portion of the wheel mounting interface; and
a second upper leg terminating at a second receiving feature in the crown and telescopically connected with the second lower leg along the second leg axis.

18. The suspension fork of claim 14, further comprising a damper interface disposed on the crown, the damper interface to facilitate user adjustment of at least one damper characteristic.

19. The suspension fork of claim 18, further comprising a spring interface disposed on the crown opposite the damper interface, the spring interface to facilitate user adjustment of at least one spring characteristic.

20. A suspension fork for a two-wheeled vehicle, the suspension fork comprising:
a steerer adaptable for handlebar control and rotatable about a steering axis;
at least one fork leg assembly, the at least one fork leg assembly including a wheel mounting interface;
a crown connecting the steerer and the at least one fork leg assembly; and
at least one rotational stop fixed on the crown, the at least one rotational stop sized and shaped to interface with a limiting feature to limit rotation of the crown about the steering axis.
